(19) United States
(12) Patent Application Publication
(10) Pub. No.: US 2004/0057735 A1
(43) Pub. Date: Mar. 25, 2004

(54) Optical transmitter using highly nonlinear fiber and method

(76) Inventor: Katsumi Uesaka, Atherton, CA (US)

Correspondence Address: MCDERMOTT, WILL & EMERY, 18191 VON KARMAN AVE., SUITE 500, IRVINE, CA, 92612-7108, US

(21) Appl. No.: 10/251,836

(22) Filed: Sep. 23, 2002

(51) Int. Cl. H04B 10/04; H04B 10/12

(52) U.S. Cl. 398/201; 398/157

(57) ABSTRACT

An optical transmitter for compensating signal distortion, the optical transmitter includes an input for accepting a signal, a laser driver for amplifying and/or reshaping the signal, a distributed feedback laser diode coupled to the laser driver for modulating the signal, a highly nonlinear fiber coupled to the distributed feedback laser diode for compensating signal distortions caused by the laser diode, and an output for sending the signal to the transmission link.

### FIELD OF THE INVENTION

The field of the present invention relates generally to optical fiber (lightwave) communication systems. More particularly, the invention relates to a direct modulation optical transmitter using highly nonlinear fiber for signal distortion compensation.

### BACKGROUND INFORMATION

There is a growing interest in high speed optical data transmission, particularly for data rates greater than 10 Gbps. To accommodate this high speed data transmission, cost effective means of lightwave modulation have been explored. One such method is the addition of an external modulator to the optical transmitter. However, external modulators add expense, complexity and/or bulk to the communication system and require additional amplifiers in the transmission line to compensate for the limited output power of the optical transmitter. Hence, an attractive alternative to external modulation is to incorporate direct modulation to a high power optical transmitter. One such direct modulation technique is to incorporate a directly modulated laser diode system (such as a distributed feedback laser diode “DFB-LD”) within the optical transmitter as shown in FIG. 1.

The advantages of the directly modulated laser diode system include its small size, low cost, low driving voltage and high output power characteristics. With direct modulation of a laser diode, an amplification-free design is achievable for long transmission distances. However, the disadvantage of this conventional system is the frequency chirp characteristic of the directly modulated laser diode system which distorts the signal and significantly limits the maximum achievable transmission distance. As shown in the example given in FIG. 1, prior art optical transmitter may include a laser driver 2 to amplify and/or reshape the input signal 6 and a distributed feedback laser diode 3 for modulation. The signal 6 is transmitted through a single mode fiber 4 and received by an optical receiver 5. The prior art system would suffer from the disadvantage noted above.

One way to analyze data transmission systems is through a generated display called an eye pattern. An eye pattern may be created by applying the received wave to the vertical deflection plates of an oscilloscope. Additionally, a sawtooth wave is applied to the horizontal deflection plates. The waveforms are then translated into a one interval display on the oscilloscope, resulting in an eye pattern similar to the one illustrated in FIG. 2. An eye pattern may also be synthesized via computer simulation. The interior region of the eye pattern is called the eye opening. The larger the width of the eye opening, the greater the time interval over which the received wave can be sampled without error from intersymbol interference. Additionally, the slope of the eye opening defines the sensitivity of the system to timing error while the height of the eye opening defines the margin over noise. See “Communication Systems”, Simon Haykin, Second Edition, pp. 496-497.

In this regard, FIG. 2 illustrates 10 Gbps output waveform signal quality after 40 km fiber transmission for the prior art optical receiver 5 by means of its simulated eye pattern discussed above. It is clear from FIG. 2 that the low eye opening height and timing jitter spreading in the eye pattern indicates that poor bit error rate performance will occur over this distance and at this data rate. Thus, the solution of the directly modulated laser diode optical transmitter has created a problem of degradation of signal quality over long distance and high speed transmission.

Prior art solutions to this problem have taken three approaches. First, a dispersion compensation fiber (DCF) (including negative dispersion fiber) can be added to the transmission line to compensate the signal distortion. However, to be an effective solution, the length of the DCF needs to be matched to the length of the conventional fibers already installed. Thus, customizing the length of the DCF for each existing fiber system is required. An alternative is to reinstall all new fibers in the transmission path with negative dispersion fiber. Either alternative is expensive. Second, installing a narrow optical bandpass filter just after the distributed feedback laser (DFB-LD) will suppress the frequency chirping of the DFB-LD. But, the narrow bandwidth requirement needed by the bandpass filter increases the sensitivity to temperature variations and causes passband stability problems. Additionally, a narrow bandwidth limits the quantity of data transmission which is not desirable. Third, optical amplifiers and/or regenerators may be added to the transmission path to overcome the dispersion penalty. However, this solution greatly increases cost, complexity and/or bulk to the transmission system.

In view of the above drawbacks, it would be desirable to have a low cost, less complex, direct modulation optical transmitter system that uses a laser diode without significant signal distortion caused by frequency chirp. It would also be desirable to have an external modulation optical transmitter system which provides greater transmission distances but without significant signal distortion caused by transmitter frequency chirp.

### SUMMARY OF THE INVENTION

The present invention addresses the drawbacks of the prior art by providing a direct modulation optical transmitter system using highly nonlinear fiber to compensate for transmitter frequency chirping. The present invention overcomes the signal distortion problem without the use of dispersion compensation fibers which require DCF length customization for each system or alternatively, replacement of existing standard fibers. The present invention compensates the signal distortion problem without the use of narrow optical band pass filters which limit data transmission at high speed. Additionally, the present invention avoids the usage of expensive and complex optical amplifiers and/or regenerators in the transmission path to avoid the distance limitation.

According to one aspect of the invention, the optical transmitter of the present invention includes an input for accepting a signal, a laser diode for direct modulation, a highly nonlinear fiber to compensate for the frequency chirp generated by the laser diode and an output for sending the optical signal to the transmission link. In a preferred embodiment, the laser diode is a distributed feedback laser diode and the highly nonlinear fiber is a highly nonlinear dispersion shifted fiber.

In another aspect of the invention, the present invention is an optical transmitter for providing signal distortion compensation which includes an input for accepting a signal, a distributed feedback laser diode for signal modulation, a highly nonlinear dispersion shifted fiber for compensating the frequency chirping caused by the distributed feedback laser diode; and an output for sending the optical signal. In a preferred embodiment, the optical transmitter also includes a laser driver for providing amplification to the input signal. As needed, the laser driver may reshape the input signal.

In yet another aspect of the invention, the present invention is a transmitter with a modulated input signal, the transmitter includes a highly nonlinear dispersion shifted fiber for compensating the frequency chirping in the signal. In a preferred embodiment, the transmitter includes a driver for amplifying and/or reshaping the signal.

In yet another aspect of the invention, the present invention is an optical transmitter system which includes an input for accepting a signal, an external modulator for signal modulation, a highly nonlinear fiber for inducing proper frequency chirping for the external modulator; and an output for sending the optical signal. In a preferred embodiment, the external modulator also includes a distributed feedback laser diode.

In yet another aspect of the invention, the present invention is optical transmission system having an optical transmitter (which includes an input for accepting a signal, an output for sending the signal, a laser diode for signal modulation and a nonlinear fiber for signal distortion compensation), an optical receiver for receiving the signal, and a transmission fiber for transmitting the signal from the optical transmitter to the optical receiver.

In yet another aspect of the invention, the present invention is an optical transmitter which includes an input for accepting a signal, a laser driver for amplifying and/or reshaping the signal, a distributed feedback laser diode for signal modulation, a highly nonlinear fiber for compensating the frequency chirping caused by the distributed feedback laser diode; and an output for sending the optical signal. In a preferred embodiment, the highly nonlinear fiber is a highly nonlinear dispersion shifted fiber.

In yet another aspect of the invention, the present invention is an optical transmitter which includes an input for accepting a signal, an modulator having a distributed feedback laser diode, an optical amplifier for amplifying the optical signal, a highly nonlinear fiber for inducing proper frequency chirping for the external modulator; and an output for sending the optical signal. In a preferred embodiment, the optical amplifier is a Raman amplifier, a semiconductor optical amplifier or an erbium doped fiber amplifier.

In yet another aspect of the invention, the present invention is a method for transmitting a signal by generating a signal, modulating the signal with a modulator and compensating distortion to the signal by passing the signal through a highly nonlinear fiber.

In yet another aspect of the invention, the present invention is a method for transmitting a signal by generating a signal, modulating the signal with a distributed feedback laser diode and compensating distortion to the signal by passing the signal through a highly nonlinear dispersion shifted fiber.

Other and further objects and advantages of the present invention will be further understood and appreciated by those skilled in the art by reference to the following specification, claims and drawings.

### BRIEF DESCRIPTION OF THE DRAWINGS

FIG. 1 is a block diagram of a prior art direct modulation optical transmission system.

FIG. 2 illustrates the simulated 10 Gbps receiver output waveform eye pattern after 40 km fiber transmission using the prior art optical transmission system.

FIGS. 3a and 3b are two block diagrams of two embodiments of optical transmission systems in accordance with the present invention.

FIG. 4 illustrates the simulated 10 Gbps receiver output waveform eye pattern after 40 km fiber transmission using an optical transmission system with a highly nonlinear fiber at its output in accordance with the present invention.

FIG. 5 is a power profile versus time graph of a laser diode output waveform simulation.

FIG. 6 is a frequency chirp profile versus time graph of a laser diode output waveform simulation comparing the effects of no chirping compensation and with chirping compensation as introduced by a highly nonlinear dispersion shifted fiber.

FIG. 7 illustrates the bit error rate (BER) characteristics for three transmission scenarios utilizing the self phase modulation of a highly nonlinear dispersion shifted fiber.

FIG. 8 illustrates the power penalty characteristics of a highly nonlinear dispersion shifted fiber for two single mode fiber lengths at a bit error rate (BER) of 10⁻⁹.

FIG. 9 illustrates the bit error rate (BER) characteristics for various pseudo random bit sequence (PRBS) lengths using highly nonlinear dispersion shifted fiber.

FIG. 10 is a block diagram of another embodiment of an optical transmission system with external modulation in accordance with the present invention.

FIG. 11 is a block diagram of yet another embodiment of an optical transmission system with external modulation in accordance with the present invention.

FIG. 12 is a block diagram of yet a different embodiment of an optical transmission system with external modulation in accordance with the present invention.

### DETAILED DESCRIPTION OF THE INVENTION

The present invention is directed to optical transmitters using highly nonlinear fiber to compensate for or modify transmitter frequency chirping. The present invention compensates for transmitter frequency chirping without using either dispersion compensation fibers in the transmission path or narrow optical band pass filters. The present invention uses highly nonlinear fiber in the optical transmitter to reduce transmitter frequency chirp and improve performance.

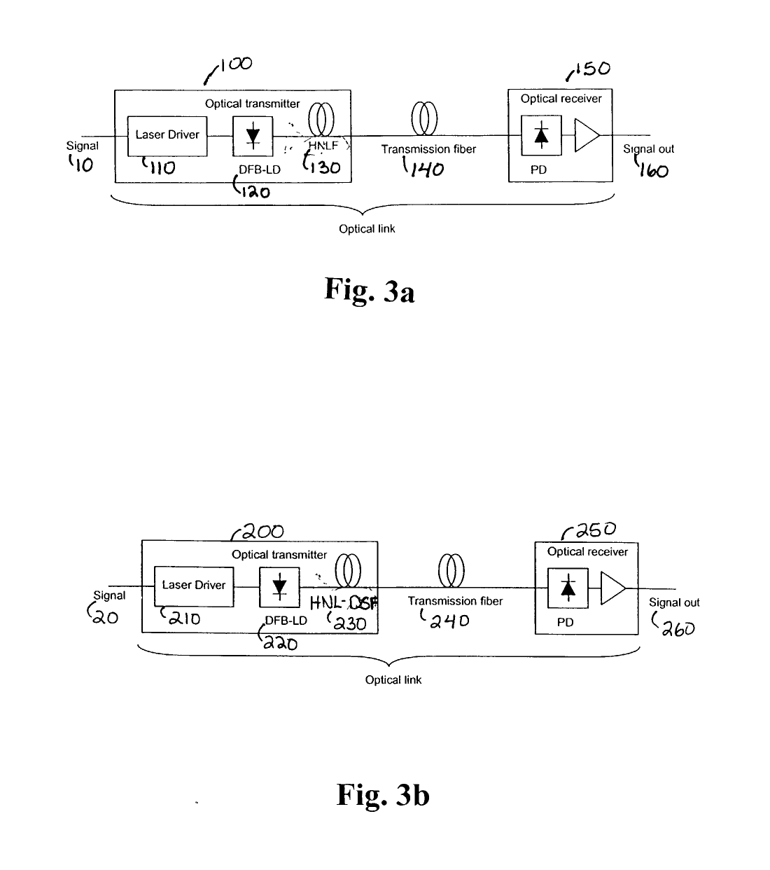

FIG. 3a is a block diagram of a first embodiment of an optical transmission system in accordance with the present invention. In a preferred embodiment, the optical transmitter 100 comprises a laser driver 110, a distributed feedback laser diode (DFB-LD) 120 and a highly nonlinear fiber (HNLF) 130. The nonlinearity characteristic of the highly nonlinear fiber 130 is desirable for compensating unwanted chirping.

The highly nonlinear fiber 130 is characterized by its self phase modulation (SPM) properties, which introduces a negative frequency chirp versus the transmitted optical pulse power level, to compensate the positive frequency chirping of the distributed feedback laser diode. The placement of the highly nonlinear fiber at the output of the distributed feedback laser diode eliminates the need to customize fiber length for each system even if the transmission fiber length varies from system to system. Additionally, there is no need to customize the fiber nonlinearity for each communication system. Rather, to optimally achieve compensation for the chirping distortion of the distributed feedback laser, certain parameters of the highly nonlinear fiber are preferred. In a preferred embodiment, the product of the length L of the highly nonlinear fiber multiplied by the nonlinearity coefficient y of the highly nonlinear fiber material is preferred to be in the range of 200-400W⁻¹. Two examples of materials suitable for highly nonlinear fibers are tellurite and chalcogenide glasses. Although these two fiber materials are mentioned, it will be appreciated that they are presented only as examples and the invention is not limited thereby.

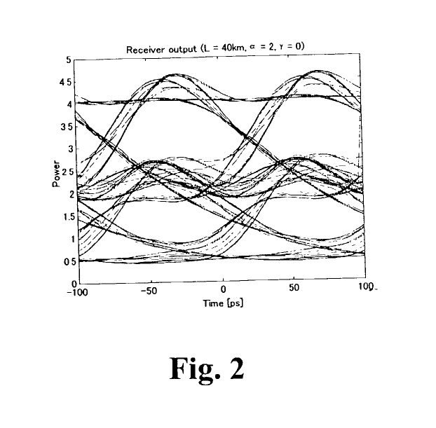

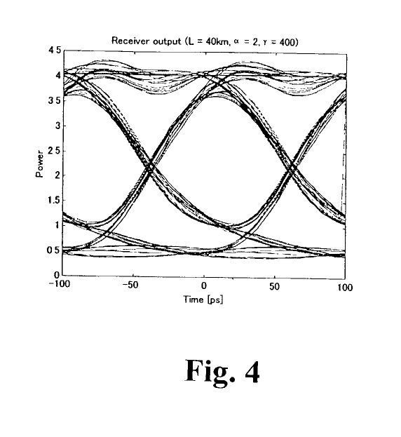

The laser driver 110 amplifies and/or reshapes the input signal 10 and feeds the input signal to the distributed feedback laser diode 120 which further amplifies and performs signal modulation. The distributed feedback laser diode 120 may or may not include cooling, depending on the application. The modulated signal is then passed through the highly nonlinear fiber 130 before being outputted from the optical transmitter 100 to the transmission fiber 140 and finally to the optical receiver 150. Frequency chirping is a byproduct of the distributed feedback laser diode 120 which results in transmitter signal distortion. If the chirping distortion is not corrected, the distorted signal characteristics at the output of the optical receiver 150 are evident from the eye pattern shown in FIG. 2. However, in the optical transmitter of the present invention, the highly nonlinear fiber 130 compensates for the frequency chirp generated by the distributed feedback laser diode 120 and a less distorted signal (as evident by the clearer eye pattern shown in FIG. 4) is passed through the transmission fiber 140 and received by the optical receiver 150.

In contrast to FIG. 2, FIG. 4 illustrates 10 Gbps output waveform signal quality after 40 km fiber transmission for the optical receiver 150, with a highly nonlinear fiber following laser diode 120, by means of its simulated eye pattern. The clean height of the eye pattern indicates low bit error rate performance is possible over this 40 km distance and at the specified data rate given the chirp compensation provided by the highly nonlinear fiber 130 at the output of the distributed feedback laser diode 120.

In another embodiment, a specific type of highly nonlinear fiber known as a highly nonlinear dispersion shifted fiber (HNL-DSF) 230 is placed at the output of a distributed feedback laser diode 220 as shown in FIG. 3b. Highly nonlinear dispersion shifted fibers, with its enhanced nonlinearity, have been developed as one of the optical functional fibers. The enhanced nonlinearity characteristic is desirable for compensating unwanted transmitter chirping. The properties of a highly nonlinear dispersion shifted fiber are described in “Silica-Based Functional Fibers With Enhanced Nonlinearity and Their Applications”, Okuno et al., IEEE Journal of Selected Topics in Quantum Electronics, Vol. 5, No. 5, September/October 1999, the disclosure of which is incorporated in its entirety herein by reference thereto. The optical communication system shown in FIG. 3b is similar to that shown in FIG. 3a except that the highly nonlinear fiber 130 is replaced by a highly nonlinear dispersion shifted fiber 230. Specifically, the optical transmitter 200 comprises a laser driver 210 for amplifying and/or reshaping the input signal 20 and then feeds the input signal into the distributed feedback laser diode 220 for signal modulation. Signal 20 is transmitted through a highly nonlinear dispersion shifted fiber 230 where its signal distortion is compensated for the frequency chirp added by the distributed feedback laser diode 220. At this point, the signal 20 is then output from the optical transmitter 200 for transmission through a transmission fiber 240 and received by the optical receiver 250.

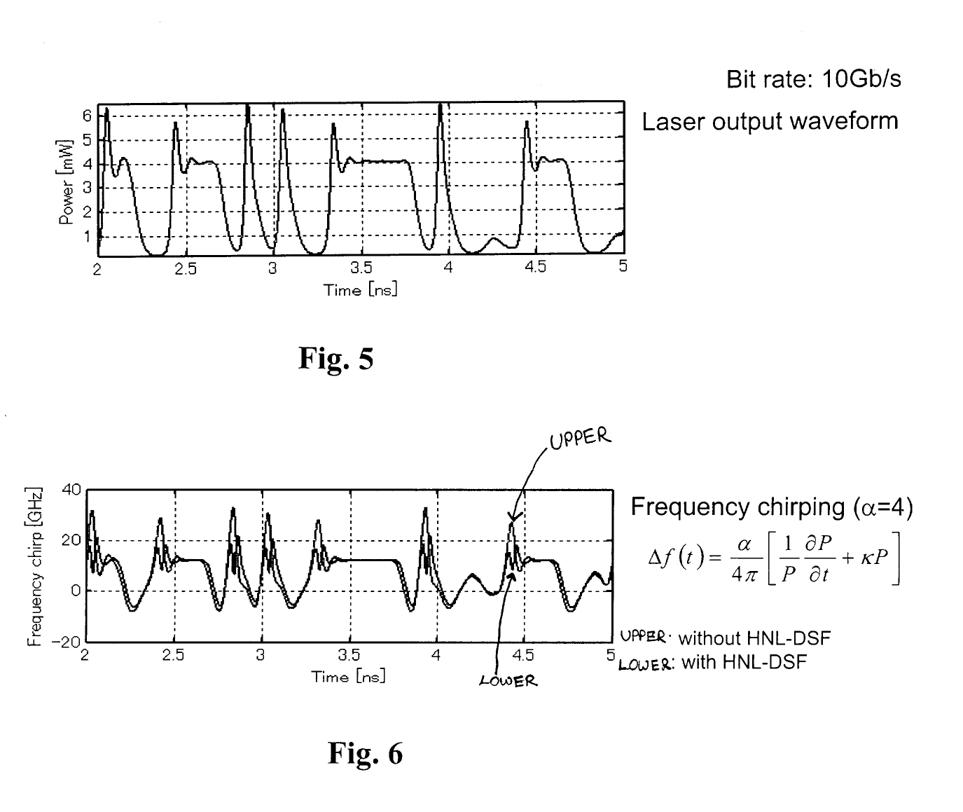

FIGS. 5-9 are performance graphs for the present invention shown in FIG. 3b. FIG. 5 is a power profile versus time graph of a distributed feedback laser diode output waveform simulation at a bit rate of 10 Gbps. FIG. 6 is a frequency chirp profile versus time graph which shows the results of the distributed feedback laser diode output waveform simulation and the chirping compensation introduced by the highly nonlinear dispersion shifted fiber 230. The upper graph displays the chirping characteristics versus time at the output of the distributed feedback laser diode 220, without the chirping compensation provided by the highly nonlinear dispersion shifted fiber 230. The lower graph displays the chirping characteristics versus time at the output of the highly nonlinear dispersion shifted fiber 230. Comparison of the upper and lower graphs indicates that the highly nonlinear dispersion shifted fiber 230 effectively reduces the frequency chirp to minimize signal distortion.

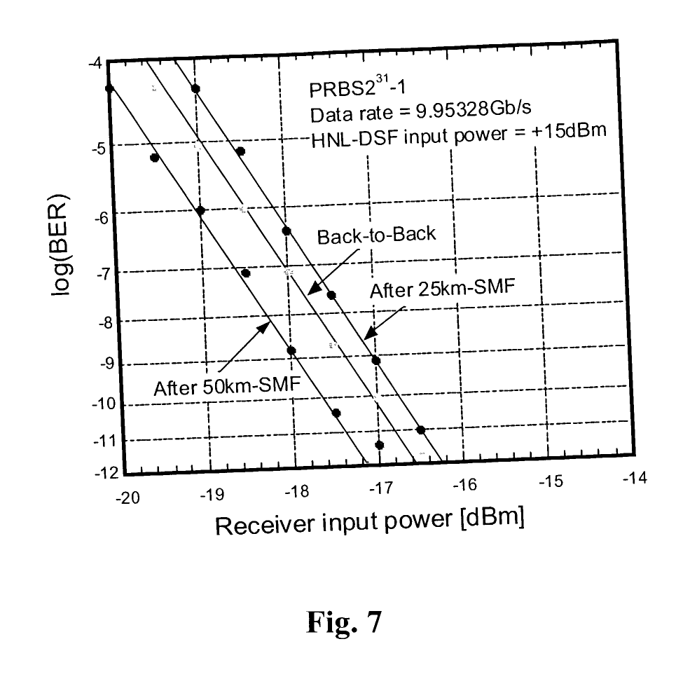

The bit error rate (BER) performance of the present invention shown in FIG. 3b is tested for various transmission scenarios. FIG. 7 illustrates the bit error rate (BER) performance for three transmission scenarios utilizing the self phase modulation of the highly nonlinear dispersion shifted fiber 230 in a laboratory setup that emulates the present invention shown in FIG. 3b in a field setting. As shown in FIG. 7, the digital bit error rate performance versus receiver input power for three fiber transmission link scenarios is summarized: back to back (zero length fiber), 25 kilometer (km) single mode fiber (SMF) and 50 km SMF. Each scenario is characterized by an HNL-DSF input power of 15 dBm. The results indicate that the best performance is obtained for the 50 km SMF case. As indicated by FIG. 6, the frequency chirp at the output of the distributed feedback laser diode 220 is reduced (i.e., compensated) after signal 20 passes through the highly nonlinear dispersion shifted fiber 230. The frequency chirp characteristics at the output of the optical transmitter 200 affect the transmission delay in the transmission SMF fiber 240. Two factors will affect how the transmission SMF fiber 240 will distort an optical signal passing through it: the SMF fiber length and the frequency chirp characteristics at the output of the optical transmitter 200. In the three scenarios illustrated in FIG. 7, the frequency chirp characteristics at the optical transmitter 200 output plus the transmission SMF fiber 240 length results in the lowest bit error rate performance for the 50 km SMF case.

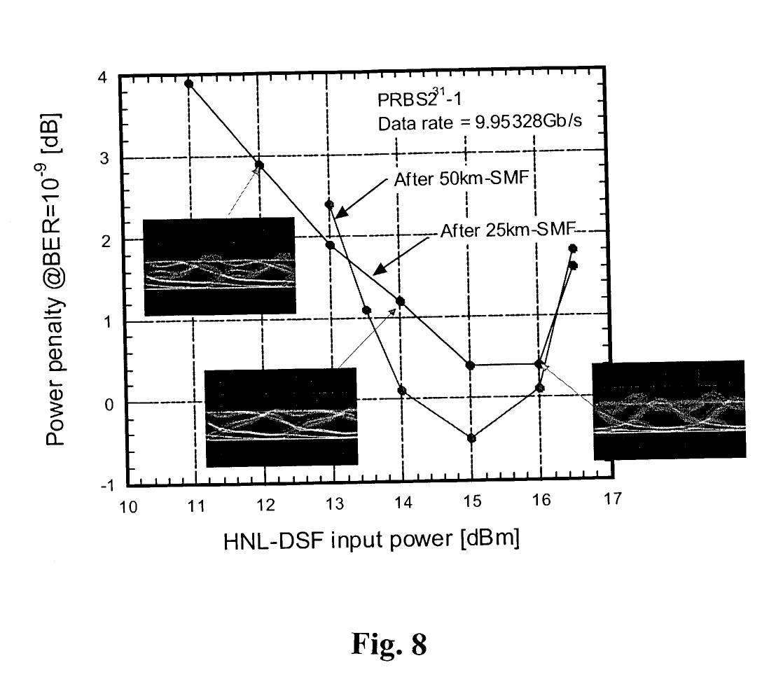

The power penalty characteristics of the present invention shown in FIG. 3b (which is tested in a laboratory setup that emulates the present invention under various transmission scenarios) is illustrated in FIG. 8. FIG. 8 illustrates the power penalty [dB] characteristics of the highly nonlinear dispersion shifted fiber 230 for two transmission fiber lengths (25 km single mode fiber and 50 km single mode fiber), at an operating point of 10⁻⁹ bit error rate, versus HNL-DSF input power [dBm]. The 50 km SMF fiber length has a lower power penalty than the 25 km SMF fiber length near the optimum input power level of around 15 dBm (at the input of the highly nonlinear dispersion shifted fiber 230). Power penalty is referenced relative to the back-to-back link scenarios at 0 dB. FIG. 8. also indicates the increased power penalty sensitivity for over pre-chirped signals versus under pre-chirped signals. To improve bit error rate performance, a forward error correction (FEC) technique (known to one of ordinary skill in the art) is combined with the pre-chirping technique of the present invention to correct transmitted signal errors. In one embodiment, the combination of forward error correction technique and the pre-chirping technique of the present invention improves communication performance. The combination of pre-chirping technique and forward error correction technique avoids the need for a booster amplifier which adds cost, complexity and/or bulk to the system.

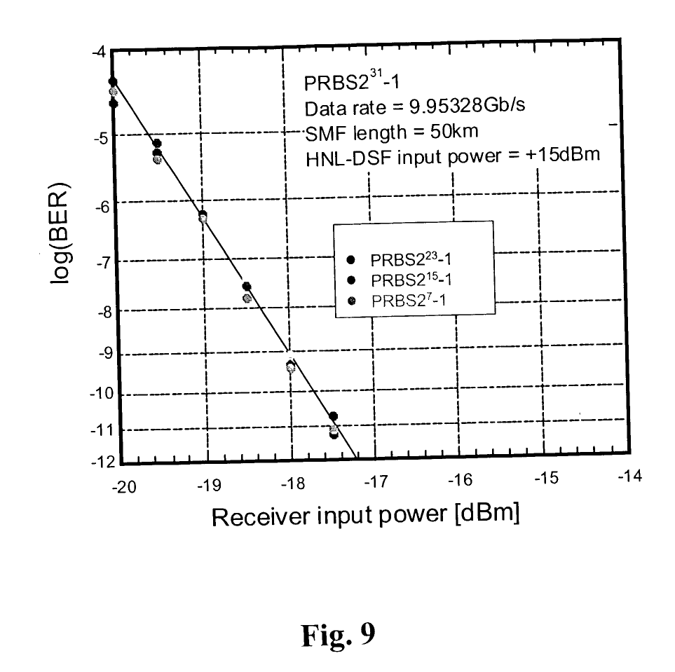

Additionally, the present invention shown in FIG. 3b is tested (in a laboratory setup that emulates the present invention) to determine dependency on binary pattern lengths. FIG. 9 illustrates the bit error rate (BER) performance for various pseudo random bit sequence (PRBS) lengths for the present invention shown in FIG. 3b. FIG. 9 summarizes the digital bit error rate performance versus receiver input power for a wide range of pseudo random bit sequence lengths, ranging from 2⁷-1 bits to 2³¹-1 bits. These results demonstrate the performance insensitivity of the present invention to pseudo random bit sequence lengths.

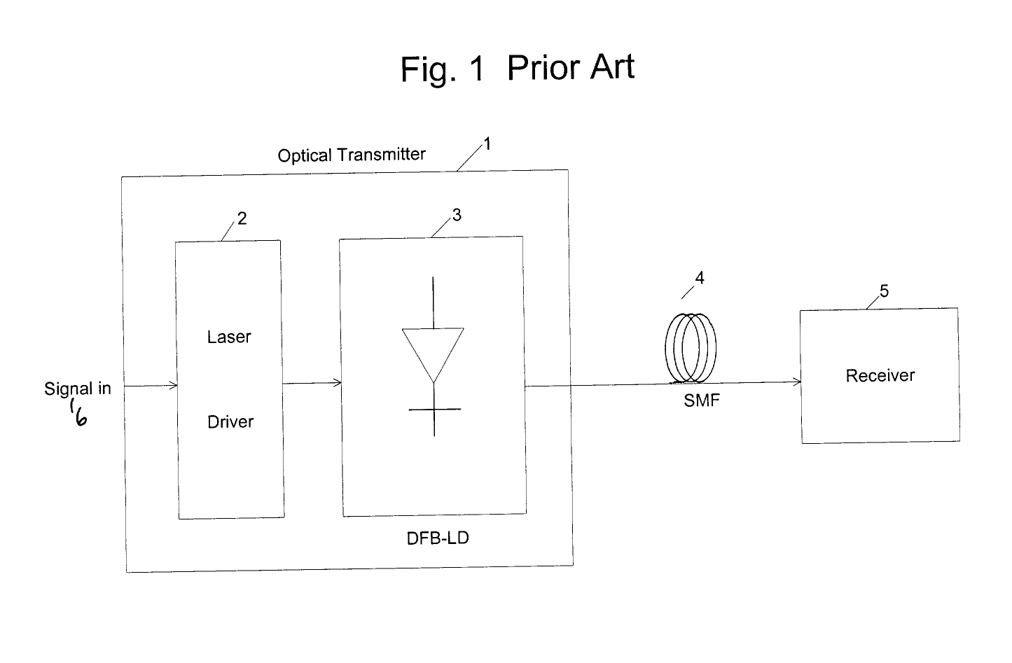

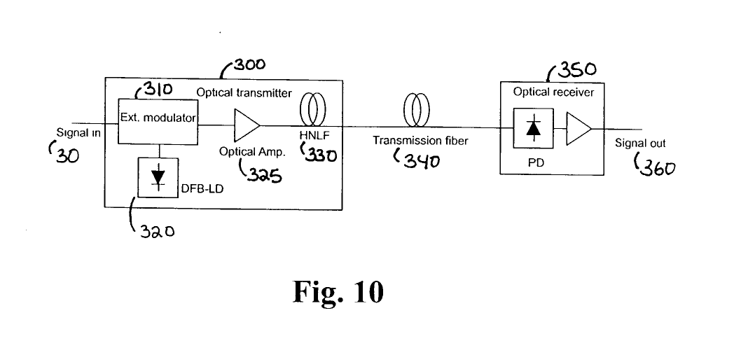

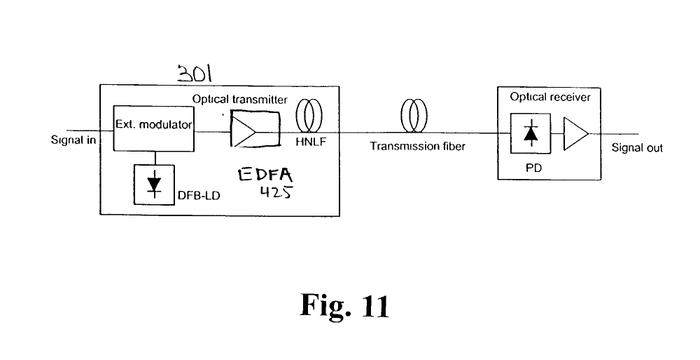

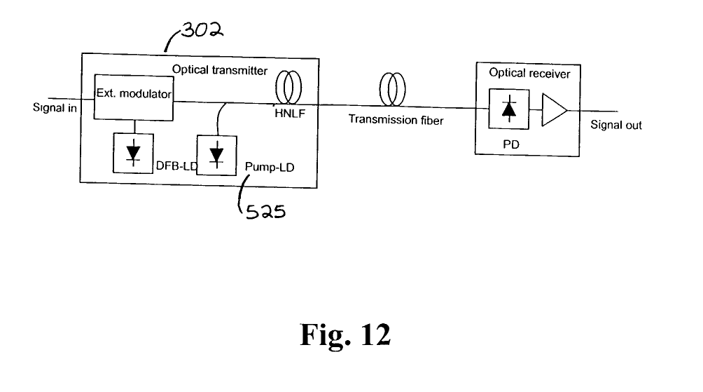

In FIG. 10, a block diagram of another embodiment of an optical transmission system is shown. The transmission system includes optical transmitter 300 comprising an external modulator 310, a distributed feedback laser diode 320 and a highly nonlinear fiber 330. The external modulator 310 accommodates high speed data transmission (particularly for bit rates greater than 10 Gbps) over long transmission lines but adds distortion to the signal 30. Since intrinsic frequency chirping is also a characteristic of transmitters using external modulators, the self phase modulation induced pre-chirping technique (discussed above with respect to FIGS. 3a and 3b) is applied to induce proper frequency chirping for the external modulators. In one embodiment, the highly nonlinear fiber 330 is placed at the output of the optical transmitter 300 to induce proper frequency chirping for the external modulator. In another embodiment, an optical amplifier 325 is included to meet the high power requirements of the external modulator 310. Here, the highly nonlinear fiber 330 is placed at the last stage of the optical transmitter 300 (at the output of the optical amplifier 325). The self phase modulation characteristics of the highly nonlinear fiber 330 induces proper frequency chirping for the external modulator 310. In a preferred embodiment, the optical amplifier 325 is a semiconductor optical amplifier (SOA) or a Raman amplifier. In one embodiment, a distributed feedback laser diode 320 is coupled to the external modulator 310. In this embodiment, the highly nonlinear fiber 330 will induce proper frequency chirping for the external modulator 310. In a preferred embodiment, as shown in FIG. 1, a specific type of highly nonlinear fiber 330, a highly nonlinear dispersion shifted fiber 430 (not shown), is used for compensating the frequency chirp of optical transmitter 301. Additionally, a specific type of optical amplifier, an erbium doped fiber amplifier 425 (EDFA), is used for amplification. In another embodiment, the optical amplifier in optical transmitter 302 includes a pump laser diode 525 as shown in FIG. 12. Although examples of optical amplifiers have been disclosed here, other forms of optical amplifiers (known to one of ordinary skill in the art) may be used with equal effectiveness in accordance with the present invention. The optical transmission systems illustrated in FIGS. 10-12, with the inclusion of highly nonlinear fibers (such as highly nonlinear dispersion shifted fibers) in the transmitters, prophetically permit long distance transmission of over 80 km to 120 km (depending on the type of external modulator used) at high speed data transmission, particularly for bit rates greater than 10 Gbps.

While the present invention has been described in terms of the preferred embodiments, other variations which are within the scope of the invention as defined in the claims will be apparent to those skilled in the art.

What is claimed is:

1. An optical transmitter comprising:
an input for inputting a signal;
a laser diode for modulating the signal;
a highly nonlinear fiber coupled to the laser diode, wherein the highly nonlinear fiber compensates for signal distortions caused by the laser diode; and
an output for outputting the signal.

2. The optical transmitter of claim 1 wherein the laser diode is a distributed feedback laser diode.

3. The optical transmitter of claim 1 wherein the highly nonlinear fiber is a highly nonlinear dispersion shifted fiber.

4. The optical transmitter of claim 1 further comprising a laser driver for amplifying and/or reshaping the signal, the laser driver being coupled to the laser diode.

5. The optical transmitter of claim 1 further comprising an optical amplifier for providing amplification to the signal, the optical amplifier being coupled to the laser diode.

6. The optical transmitter of claim 5 wherein the optical amplifier includes a pump laser diode.

7. The optical transmitter of claim 5 wherein the optical amplifier is an erbium doped fiber amplifier.

8. The optical transmitter of claim 5 wherein the optical amplifier is a Raman amplifier.

9. The optical transmitter of claim 5 wherein the optical amplifier is a semiconductor optical amplifier.

10. The optical transmitter of claim 2 further comprising a laser driver for amplifying and/or reshaping the signal, the laser driver being coupled to the distributed feedback laser diode.

11. The optical transmitter of claim 2 further comprising an optical amplifier for providing amplification to the signal, the optical amplifier being coupled to an output of the distributed feedback laser diode.

12. The optical transmitter of claim 11 wherein the optical amplifier includes a pump laser diode.

13. The optical transmitter of claim 11 wherein the optical amplifier is an erbium doped fiber amplifier.

14. The optical transmitter of claim 11 wherein the optical amplifier is a Raman amplifier.

15. The optical transmitter of claim 11 wherein the optical amplifier is a semiconductor optical amplifier.

16. The optical transmitter of claim 3 further comprising a laser driver for amplifying and/or reshaping the signal, the laser driver being coupled to the laser diode.

17. The optical transmitter of claim 3 further comprising an optical amplifier for providing amplification to the signal, the optical amplifier being coupled to an output of the laser diode.

18. The optical transmitter of claim 17 wherein the optical amplifier includes a pump laser diode.

19. The optical transmitter of claim 17 wherein the optical amplifier is an erbium doped fiber amplifier.

20. The optical transmitter of claim 17 wherein the optical amplifier is a Raman amplifier.

21. The optical transmitter of claim 17 wherein the optical amplifier is a semiconductor optical amplifier.

22. The optical transmitter of claim 1 wherein the highly nonlinear fiber includes tellurite glass.

23. The optical transmitter of claim 1 wherein the highly nonlinear fiber includes chalcogenide glass.

24. An optical transmitter comprising:
an input for inputting a signal;
a distributed feedback laser diode for modulating the signal;
a highly nonlinear dispersion shifted fiber coupled to the distributed feedback laser diode wherein the highly nonlinear dispersion shifted fiber compensates for frequency chirping caused by the distributed feedback laser diode; and
an output for outputting the signal.

25. The optical transmitter of claim 24 further comprising a laser driver for amplifying and/or reshaping the signal, the laser driver being coupled to the distributed feedback laser diode.

26. The optical transmitter of claim 24 further comprising an optical amplifier for providing amplification to the signal, the optical amplifier being coupled to an output of the distributed feedback laser diode.

27. The optical transmitter of claim 26 wherein the optical amplifier includes a pump laser diode.

28. The optical transmitter of claim 26 wherein the optical amplifier is an erbium doped fiber amplifier.

29. The optical transmitter of claim 26 wherein the optical amplifier is a Raman amplifier.

30. The optical transmitter of claim 26 wherein the optical amplifier is a semiconductor optical amplifier.

31. A transmitter having a modulated signal, comprising:
a highly nonlinear dispersion shifted fiber for compensating frequency chirp in the signal.

32. The transmitter of claim 31 further comprising a driver for amplifying and/or reshaping the signal, the driver being coupled to the highly nonlinear dispersion shifted fiber.

33. The transmitter of claim 32 further comprising a high power amplifier for providing final amplification to the signal, the amplifier being coupled to the highly nonlinear dispersion shifted fiber.

34. An optical transmitter system comprising:
an input for inputting a signal;
an external modulator for modulating the signal;
a highly nonlinear fiber coupled to the external modulator, wherein the highly nonlinear fiber induces proper frequency chirping for the external modulator; and
an output for outputting the signal.

35. The optical transmitter system of claim 34 wherein the external modulator further comprises a distributed feedback laser diode.

36. The optical transmitter system of claim 35 wherein the highly nonlinear fiber is a highly nonlinear dispersion shifted fiber.

37. The optical transmitter system of claim 36 further comprising an optical amplifier for providing amplification to the signal, the optical amplifier being coupled to an output of the external modulator.

38. The optical transmitter system of claim 37 wherein the optical amplifier includes a pump laser diode.

39. The optical transmitter system of claim 37 wherein the optical amplifier is an erbium doped fiber amplifier.

40. The optical transmitter of claim 37 wherein the optical amplifier is a Raman amplifier.

41. The optical transmitter of claim 37 wherein the optical amplifier is a semiconductor optical amplifier.

42. An optical transmission system comprising:
an optical transmitter having an input for accepting a signal and an output for sending the signal, the optical transmitter having a laser diode for signal modulation and a highly nonlinear fiber coupled to the laser diode, wherein the highly nonlinear fiber compensates for signal distortions caused by the laser diode;
an optical receiver for receiving the signal; and
a transmission fiber coupled to the output of the optical transmitter for transmitting the signal to the optical receiver.

43. The optical transmission system of claim 42 wherein the highly nonlinear fiber is a highly nonlinear dispersion shifted fiber.

44. The optical transmission system of claim 42 wherein the optical transmitter further comprises a laser driver for amplifying and/or reshaping the signal, the laser driver being coupled to the laser diode.

45. The optical transmission system of claim 42 wherein the optical transmitter further comprises an optical amplifier for providing amplification to the signal, the optical amplifier being coupled to an output of the laser diode.

46. The optical transmitter of claim 45 wherein the optical amplifier includes a pump laser diode.

47. The optical transmitter of claim 45 wherein the optical amplifier is an erbium doped fiber amplifier.

48. The optical transmitter of claim 45 wherein the optical amplifier is a Raman amplifier.

49. The optical transmitter of claim 45 wherein the optical amplifier is a semiconductor optical amplifier.

50. The optical transmission system of claim 42 wherein the optical transmitter further comprises an optical amplifier for providing amplification to the signal, the optical amplifier being coupled to an output of the laser diode.

51. The optical transmission system of claim 50 wherein the highly nonlinear fiber is a highly nonlinear dispersion shifted fiber.

52. The optical transmission system of claim 42 wherein the transmission fiber is a single mode fiber.

53. An optical transmitter comprising:
an input for inputting a signal;
a laser driver for amplifying and/or reshaping the signal;
a distributed feedback laser diode coupled to the laser driver, wherein the laser diode modulates the signal;
a highly nonlinear fiber coupled to the distributed feedback laser diode, wherein the highly nonlinear fiber compensates for signal distortions caused by the laser diode; and
an output for outputting the signal.

54. The optical transmitter of claim 53 wherein the highly nonlinear fiber is a highly nonlinear dispersion shifted fiber.

55. An optical transmitter comprising:
an input for inputting a signal;
an external modulator for modulating the signal, the external modulator including a distributed feedback laser diode;
an optical amplifier coupled to the external modulator, wherein the optical amplifier amplifies the signal;
a highly nonlinear fiber coupled to the optical amplifier, wherein the highly nonlinear fiber induces proper frequency chirping for the external modulator; and
an output for outputting the signal.

56. The optical transmitter of claim 55 wherein the optical amplifier is an erbium doped fiber amplifier.

57. The optical transmitter of claim 55 wherein the optical amplifier is a Raman amplifier.

58. The optical transmitter of claim 55 wherein the optical amplifier is a semiconductor optical amplifier.

59. The optical transmitter of claim 55 wherein the optical amplifier includes a pump laser diode.

60. A method for transmitting a signal comprising:
generating a signal;
modulating the signal with a modulator; and
compensating distortion to the signal by passing the signal through a highly nonlinear fiber.

61. The method of claim 60 wherein the distortion is a frequency chirp.

62. The method of claim 60 wherein the highly nonlinear fiber is a highly nonlinear dispersion shifted fiber.

63. The method of claim 60 wherein the modulator is a laser diode.

64. The method of claim 60 wherein the laser diode is a distributed feedback laser diode.

65. The method of claim 60 wherein the modulator is an external modulator.

66. The method of claim 65 wherein the external modulator includes a distributed feedback laser diode.

67. The method of claim 66 further comprising amplifying the signal.

68. The method of claim 60 further comprising transmitting the signal through a single mode fiber; and
an optical receiver receiving the signal.

69. The method of claim 68 further comprising adding forward error correction (FEC) coding to the signal for correcting at least one signal error.

70. A method for transmitting a signal comprising:
generating a signal;
modulating the signal with a distributed feedback laser diode; and
compensating distortion to the signal by passing the signal through a highly nonlinear dispersion shifted fiber.

71. The method of claim 70 further comprising transmitting the signal through a single mode fiber; and
an optical receiver receiving the signal.

72. The method of claim 70 further comprising adding forward error correction (FEC) coding to the signal for correcting at least one signal error.
